(19) United States
(12) Patent Application Publication
(10) Pub. No.: US 2026/0071640 A1
(43) Pub. Date: Mar. 12, 2026

(54) FASTENER WITH ADJUSTABLE LOCKING INSERT

(71) Applicants: Ned C Bowers, Mount Dora, FL (US); Russell Ortner, Apopka, FL (US)

(72) Inventors: Ned C Bowers, Mount Dora, FL (US); Russell Ortner, Apopka, FL (US)

(21) Appl. No.: 19/240,224

(22) Filed: Jun. 17, 2025

Related U.S. Application Data
(60) Provisional application No. 63/661,085, filed on Jun. 18, 2024.

(51) Int. Cl. F16B 5/10; F16B 5/02

(52) U.S. Cl. CPC F16B 5/10; F16B 5/02

(57) ABSTRACT

A fastener assembly for securing together two components such as two panels. The assembly includes an externally threaded insert that is rotatably adjustable within an internally threaded receptacle on a nut plate. A toolless locking mechanism of the assembly includes a retainer clip that interfaces with a rotatable actuator on the receptacle to move a tab end of clip in and out of engagement with the insert to unlock the insert for rotation in the receptacle or lock the insert to prevent rotation thereof in the receptacle.

### BACKGROUND OF THE INVENTION

The invention disclosed and claimed herein relates to a fastener used to secure together two components, such as panels. More specifically, the invention pertains to a quarter-turn fastener with an adjustable locking insert.

Quarter-turn fasteners are typically used in connection with securing together two components such as two panels. Such fasteners are used in automotive, marine and aerospace industries and include a grommet and stud assembly connected to one panel that interconnects with and engages a receptable/insert assembly mounted to another panel. The receptacle/insert assembly is configured to receive the stud to secure together the panels. The insert is adjustable axially within the receptacle to accommodate varying thicknesses of panels.

Prior art quarter-turn fasteners are described, for example, in U.S. Pat. Nos. 5,688,093; 5,795,122 (the '122 Patent); 7,997,843 and 8,282,329. The prior art fastener of the '122 Patent is shown in FIGS. 24-26. As shown, the fastener 410 includes internally threaded receptacle 414 is secured to one side of a first panel using known methods such as rivets and the like, and/or adhesive/bonding agents. The receptacle 414 includes internal threading to receive an externally threaded insert 416, which is adapted to receive cross pins of a grommet-stud assembly 420, which is attached to and extends through a second panel (not shown) to be secured to the first panel. The insert 416 includes cam and locking surfaces 444 to receive the cross-pins 421 of the stud/grommet assembly 420 of the second panel to secure the same in the insert 416 and the two panels, as is well known to one skilled in the art, and further described in

Some prior art fastener assemblies include what is known as a floating nut plate design wherein the receptacle 414 and insert 416 are moveable for alignment with apertures in the panels to receive the grommet/stud assembly 420. The axial or longitudinal position of the insert 416 within the receptacle 414 may have to be adjusted to accommodate different thicknesses of panels so the stud/grommet assembly 420 securely interfaces with the cam and locking surfaces. To that end, insert 416 is rotatable with in the receptacle 414; however, a locking mechanism should be provided to lock the insert in a non-rotating position.

A prior art fastener that includes an adjustable locking insert includes the SK213 series available on the website www.skybolt.com, which includes a spring-loaded band on the receptacle. Such a fastener is also disclosed in the above-referenced '122 Patent. The receptacle 414 and insert 416 are adapted with slots and channels to receive a bend end of spring-loaded band 424, which is biased inward and outward relative to the insert using a tool 426 such as a small pick, as shown in FIG. 25. Band 424 is composed of steel and is subject to cracking and corrosion at the bend. In addition, the pick may be difficult to manipulate for moving the band 424 during installation especially in small or tight places.

### SUMMARY OF THE INVENTION

A fastener assembly, according to aspects of various embodiments, the invention may comprise a nut plate and an internally threaded cylindrical receptacle supported on the nut plate. The receptacle may include a first end facing a surface of the nut plate and a second end opposite the first end, and a slot through the receptacle between the first end and the second end.

In addition, the fastener assembly may comprise an externally threaded insert disposed within the receptacle and axially adjustable therein. The insert may comprise a first end facing the nut plate and a second end opposite the first end. A boring may extend through the insert including through the first end and second end of the insert. The insert may also include a pair of diametrically opposed cam and locking surfaces from the second end terminating toward the first end and spaced from the first end, for receiving and engaging a cross pin of a stud; and, at least one channel extending from the first end to the second of the insert and through the external threading on the insert, and parallel to a longitudinal axis of the insert.

An actuator may be disposed adjacent to an external surface of the receptable and rotatable thereon. The actuator may comprise a cylindrical body disposed over the receptacle having a first end facing the nut plate and a second end opposite the first end; and an opening through a side of the actuator body between the first end and the second end of the actuator, and the opening includes a first edge and second opposite edge.

A retainer clip may be provided having a curved section extending at least partially circumferentially about an external surface of the actuator body and an end extending radially inward relative to the actuator through the opening of the actuator, the slot of the receptacle and into the channel of the insert for an insert locked position. The retainer clip is preferably configured to apply a spring-loaded compressive force against the body of the actuator; and, wherein the actuator is rotatable about the receptacle in a first direction to move the first end of the retainer clip out of the channel of the insert to an unlocked position.

The invention is not limited to the specific embodiments disclosed herein and covers a fastener assembly in which a radius of the retainer clip and radius of an outer surface (external surface) of the actuator vary relative to one another such that rotation or movement of the actuator results in biasing the clip outward or inward relative to the insert and receptacle, depending on the direction of rotation of the actuator. To that end, aspects of the invention wherein this variation in radii between two components is adjacent to a part that is biased in an out of a locking interface with the insert of the fastener assembly.

### BRIEF DESCRIPTION OF THE DRAWINGS

FIG. 1 is a perspective exploded view of a first embodiment of a fastener assembly according to aspects of the invention.

FIG. 2 is a perspective view of the fastener assembly.

FIG. 3 is a side view of the fastener assembly.

FIG. 4 is a top perspective view of an actuator according to aspects of the invention.

FIG. 5 is a side elevation view of the actuator shown in FIG. 4.

FIG. 6 is a sectional view of the actuator taken along line 6-6 of FIG. 5.

FIG. 7 is a sectional view of the actuator taken along line 7-7 of FIG. 5 and showing a cam surface of the actuator.

FIG. 8 is a perspective view of a receptacle according to aspects of the invention.

FIG. 9 is a top view of a retainer clip according to aspects of the invention.

FIG. 10 is a perspective view of a key according to aspects of the invention.

FIG. 11 is a top perspective view of an insert according to aspects of the invention.

FIG. 12 is a top view of the insert.

FIG. 13A is a partial sectional view of the actuator rotated to an inert locked position.

FIG. 13B is a sectional view of the fastener taken along line 13B-13B of FIG. 13A.

FIG. 14A is a partial sectional view of the actuator rotated to an insert unlocked position.

FIG. 14B is a sectional view of the fastener taken along line 14B-14B of FIG. 14A.

FIG. 15 is an exploded perspective view of a second embodiment of a fastener assembly according to aspects of the invention.

FIG. 16 is a top perspective view of the fastener assembly.

FIG. 17 is a perspective view of an actuator of the fastener assembly.

FIG. 18 is a sectional view of the actuator taken along line 18-18 of FIG. 17.

FIG. 19 is a perspective view of a receptacle of the fastener assembly.

FIG. 20 is a perspective view of the retainer clip of the fastener assembly.

FIG. 21 is a top view of the retainer clip.

FIG. 22A is an end view of the second embodiment of the fastener assembly to an insert locked position.

FIG. 22B is a sectional view of the fastener assembly taken along line 22B-22B of FIG. 22A.

FIG. 23A is an end view of the second embodiment of the fastener assembly in an inert unlocked position.

FIG. 23B is a sectional view taken along line 23B-23B of FIG. 23A.

FIG. 24 is a top view of a retainer clip according to aspects of the invention.

FIG. 25 is a perspective view of a fastener assembly according to aspects of the invention.

FIGS. 26-28 are side views of a prior art fastener assembly.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items, elements or steps. Furthermore, the indefinite article “a” or “an” is meant to indicate one or more of the items, elements or steps modified by the article. As used herein, unless otherwise clear from the context, a value is “about” another value if it is within a factor of two (twice or half) of the other value. While example ranges are given, unless otherwise clear from the context, any contained ranges are also intended in various embodiments. Thus, a range from 0 to 10 includes the range 1 to 4 in some embodiments.

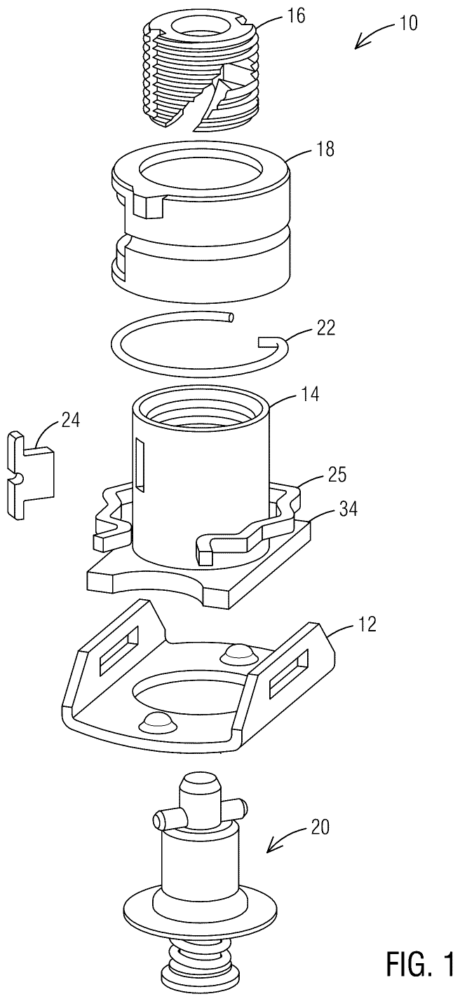

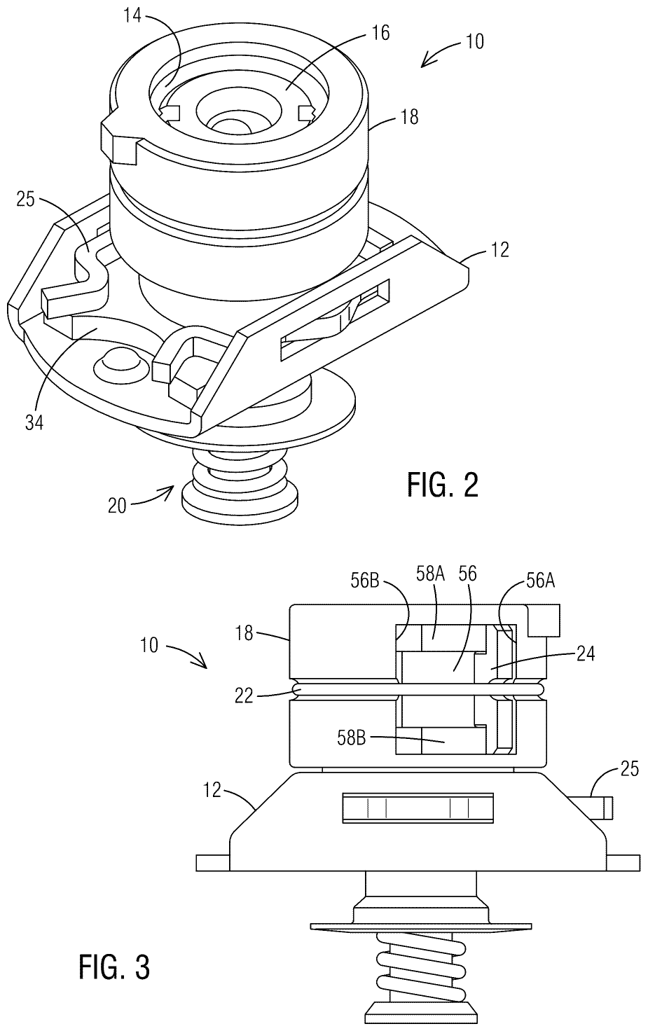

An embodiment of a fastener or fastener assembly 10 according to aspects of the invention is shown, for example, in FIGS. 1-3. The fastener 10 described herein is of a quarter-turn variety that is used in connection with securing together two components such as two panels. Such fasteners are used in automotive, marine and aerospace industries and include a grommet and stud assembly connected to one panel that interconnects and engages and receptable/insert assembly mounted to another panel. The receptacle/insert assembly is configured to receive the stud for engagement to secure together the panels. The insert is adjustable axially within the receptacle to accommodate varying thicknesses of panels.

According to aspects of an embodiment of the invention, the fastener 10 includes a nut plate 12 that supports other fastener components on a panel or component. Nut plate 12 is secured to one side of one of a first panel (not shown) using known methods such as rivets and the like, and/or adhesive/bonding agents. An internally threaded, cylindrical receptable 14 is disposed on nut plate 12 and secured thereon with a spring-loaded retainer device 25 that engages the nut plate 12 and receptacle 14.

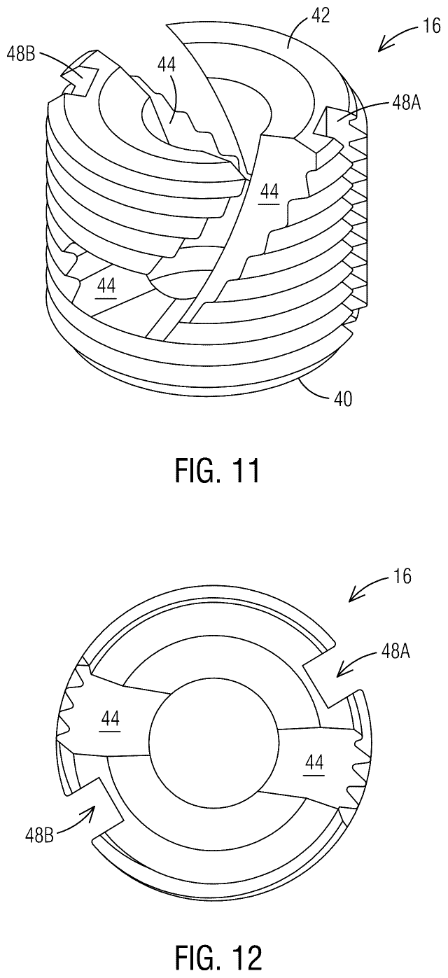

The receptacle 14 includes internal threading 28 to receive an externally threaded insert 16, which is adapted to receive cross pins of a grommet-stud assembly 20, which is attached to and extends through a second panel (not shown) to be secured to the first panel. With respect to FIGS. 11 and 12, the insert 16 includes cam and locking surfaces 44 to receive the cross-pins of the stud/grommet assembly 20 through the second panel to secure the same in the insert 16 and the two panels, as is known to one of ordinary skill in the art.

For similar prior art fasteners such an arrangement is known as a floating nut plate design wherein the receptacle 14 and insert 16 are moveable for alignment with apertures in the panels to receive the grommet/stud assembly 20. The axial or longitudinal position of the insert 16 within the receptacle 14 may have to be adjusted to accommodate different thicknesses of panels so the stud/grommet assembly 20 securely interfaces with the cam and locking surfaces. To that end, insert 16 is rotatable with in the receptacle 14; however, a locking mechanism should be provided to lock the insert 16 in a non-rotating position.

The subject invention solves the above-referenced problem by incorporating a unique locking mechanism by eliminating a need for a separate tool to lock and unlock the insert 16 for axial positioning in the receptacle. More specifically, in the first embodiment key 24 is biased into a locking (first) position relative to the receptable 14 and insert 16 by a spring-loaded retainer clip 22. The key 24 interfaces with cam surfaces 58A, 58B between the key 24 and receptable 14, and the cam surfaces 58A, 58 are rotatable relative to the key 24 and receptable 14 to urge the key 24 outward to an unlocked (second) position, so the insert 16 is rotatable in the receptacle 14 to a desired axial position.

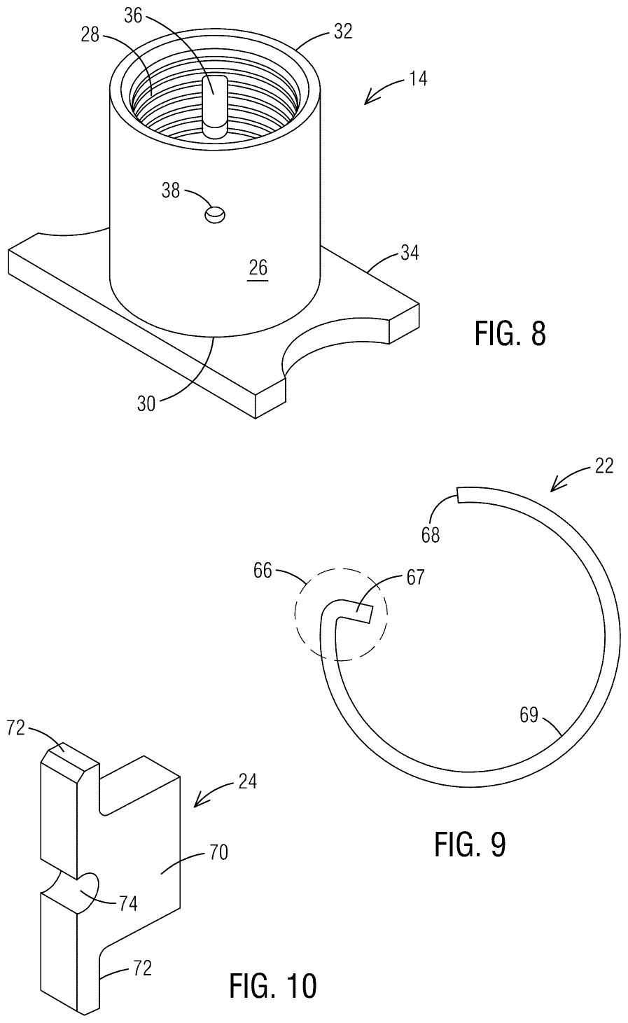

Receptacle 14 is shown in more detail in FIGS. 1 and 8. Receptacle 14 includes a first end 30 mounted to a base 34 facing nut plate 12, and a second, open end 32 open opposite the first end 30. As referred to above, receptacle 14 includes internal threading 28 to receive the externally threaded insert 16. A through-slot 36 is provided on the receptacle 14, through which a planar member 70 of the key 24 is inserted to engage the insert 16 to lock and unlock the insert 16 from or for rotation. In addition, a lock detent 38 is disposed on the outer surface 26 of receptacle 14 opposite or diametrically opposed relative to the through slot 36. As explained in more detail below lock detent 38 is available for locking insert 16 in position within receptacle 14.

Insert 16 is illustrated in more detail with respect to FIGS. 1, 11, and 12. As shown, insert 16 includes a first end 40 facing the nut plate 12 and a second end 42 opposite the first end 40. A boring 46 is through insert 16 including the first end 40 and second end 42 of insert 16. A pair of diametrically opposed cam and locking surfaces 44A, 44B are provided through the second end 42 and body 43 of the insert 16 terminating spaced from the first end 40. Channels 48A, 48B are diametrically opposed on the insert 16 from the first end 40 to the second end 42 and through the external threading 49 of the insert 16. Channels 48A, 48B are positioned and dimensioned to receive the key 24 or planar member 70 of the key 24. While the above-described configuration of insert 16 is described as including a pair of channels 48A, 48B, it is not so limited, and it may include one or more channels or more or less than two channels.

As mentioned above, one or more cam surfaces are moveable or rotatable relative along an outer surface 26 of receptacle 14 to move the key 14 in and out of the channels 48A, 48B of insert 16 to lock and unlock the insert 16. In an embodiment, the cam surfaces 58A, 58A are provided via an actuator 18 disposed on and rotatable relative to the receptacle 14 which remains fixed on the nut plate 12.

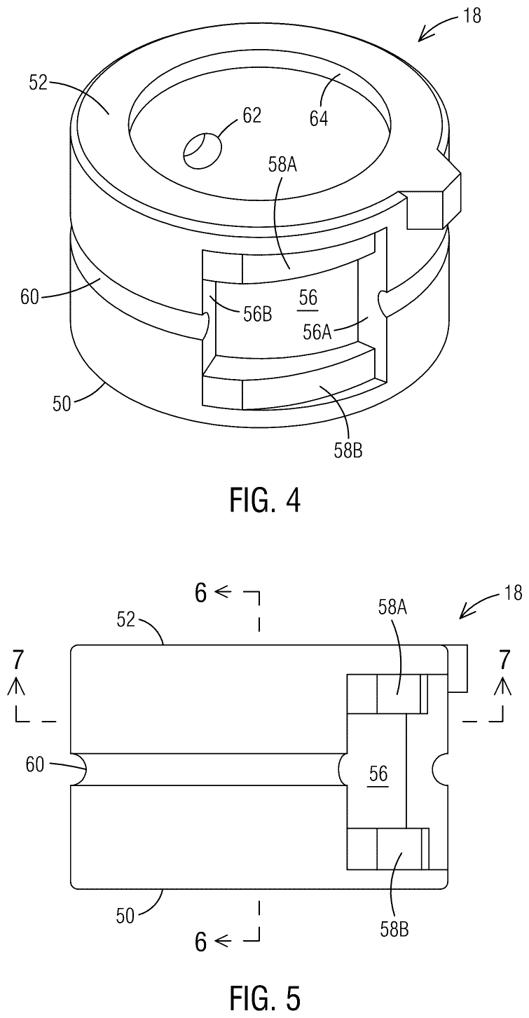

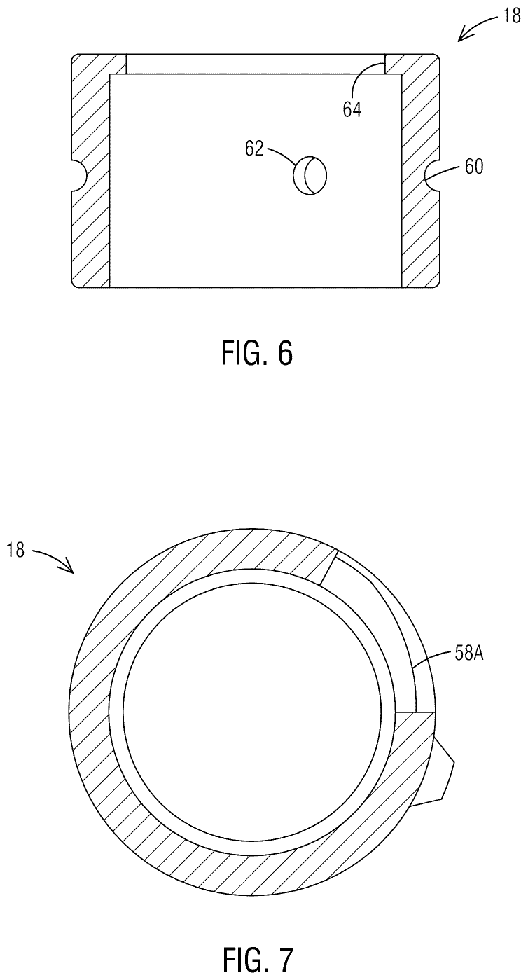

With respect to FIGS. 4 and 5, actuator 18 and its components are shown in more detail. Like the receptacle 14 and insert 16, the actuator 18 has a generally hollow cylindrical geometric configuration including an open first end 50 and open second end 52. Actuator 18 has an inside diameter that is larger than an outside diameter of receptacle 14 to fit over and rotate relative to receptacle 14.

In the embodiment shown herein, side opening 56 is disposed along and through the side/body 45 of actuator 18 and through which the key 24 is inserted and disposed. The opening includes a first side edge 56A spaced from a second side edge 56B. Cam surfaces 58A, 58B are space apart from each other extending between side edges 56A, 56B. As shown in the section view of FIG. 4, the cam surfaces 58A, 58B, are integral components of the actuator 18 meaning a thickness of the sleeve at the location of the cam surfaces 58A, 58B thickens or narrows, depending on the direction of measurement, between the side edges 56A, 56B of window 56.

In addition, the second end 52 of actuator 18 may include a rim 64 that overhangs the second end 32 of the receptacle 14 supporting the actuator 18 on the receptacle 14 and aligning the two components.

The key 18, shown in more detail in FIG. 10, includes a planar member or tab 70 and guide catches 72, which interface with the cam surfaces 58A, 58B. A retainer clip 22 (FIG. 9) is fixed to actuator 18 and seated the groove 60 that extends circumferentially around the actuator 18 from one side edge 56A to the other side edge 56B of opening 56.

Clip 22, in an embodiment, has a wire-type configurating having a hooked first end 66 including a tang 67 that is spaced from a second end 68 and a curvilinear mid-section 69 therebetween. The tang 67 is inserted in aperture 62 (FIG. 4) disposed within groove 60.

Clip 22 is positioned on actuator 18 such that the mid-section 69 traverses opening 56 and is seated in notch or recess 74 of key 24. By application of a compressive force from the spring-loaded nature of clip 22, the clip 22 biases the key 24, including the tab 70, into or through the window 56 inward toward the receptacle 14. As will be explained in more detail, the actuator 18 and cam surfaces 58A, 58B are rotated on the receptacle 14 to urge or move the key 24 relative the insert 16 to lock or unlock the insert 16 within receptacle 14.

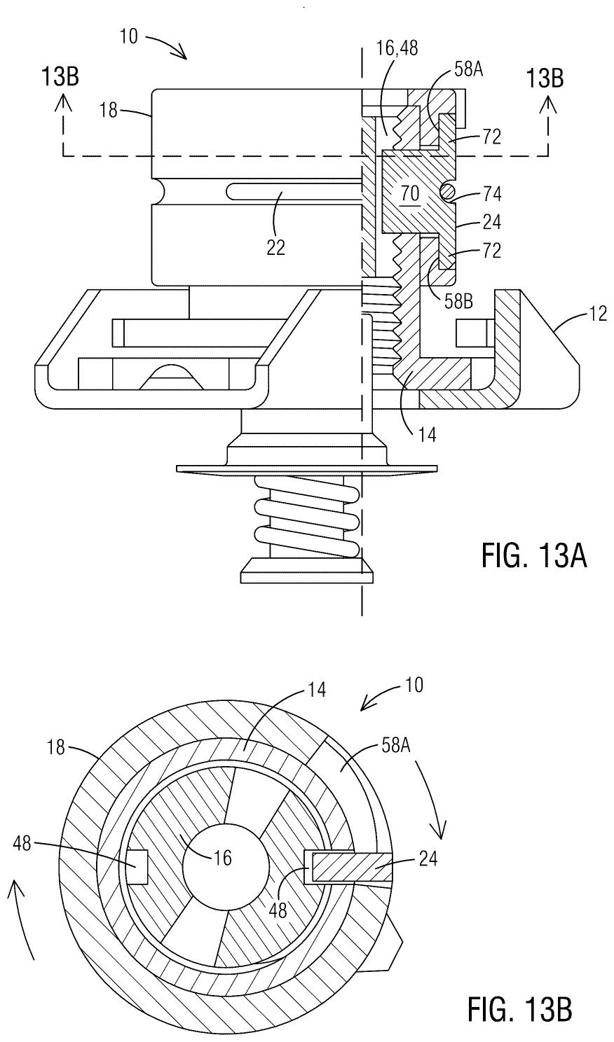

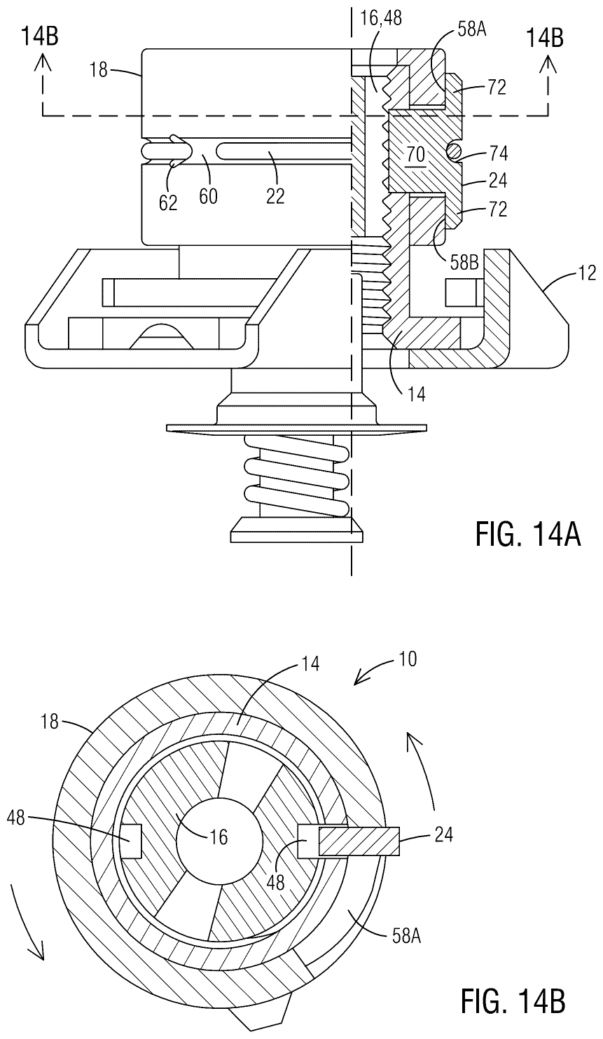

Insert 16 is shown in a locked position (FIGS. 13A, 13B) and unlocked position (FIGS. 14A, 14B), respectively. In reference to FIGS. 13A, 13B, actuator 18 has been rotated to a first position whereby the first side edge 56A of opening 56 is aligned relative to slot 36 of receptacle 16 along the narrower portion of the cam surfaces 58A, 58B, so the clip 22 urges the key 24 inward through the slot 36 so the planar member or tab 70 is disposed within the channel 48 of insert 16. To that end, the hook end or tang 67 is seated in the lock detent 38 aperture 62 of groove 60, anchoring the clip 22 in the groove 60 and on the actuator 18.

As shown in FIG. 13B, which is a bottom section view, actuator 18 is rotated in a clockwise direction, as indicated by arrows, from the locked position (first position) to an unlocked position (second position, FIG. 14B). As actuator 18 rotates the ramping or widening of the cams associated with cam surfaces 58A, 58B urge the key 24 outward relative to the insert 16 by engagement at the interface of the cam surfaces 58, 58B with the guide catches 72. In this manner, the planar member or tab 70 of key 24 is removed from channel 48 so the insert 16 is rotatable in the receptacle 14 to a desired axial position. Once that position is found, channel 48A or 48B is aligned with key 24 and the actuator 18 is rotated in a counterclockwise direction, in this example, or according to a direction indicated by the arrows of FIG. 14B, so clip 22 biases the key 24 into a channel 48A or 48B, through slot 36 of the receptacle 14.

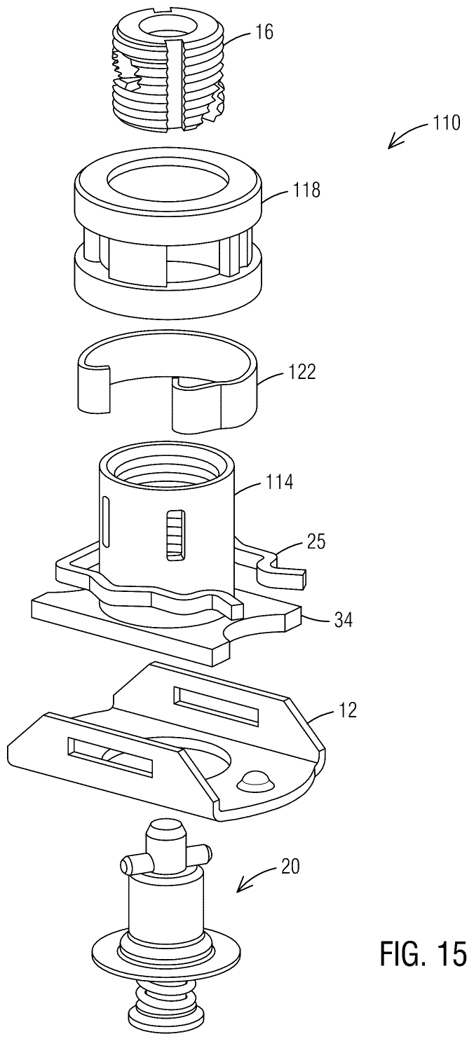

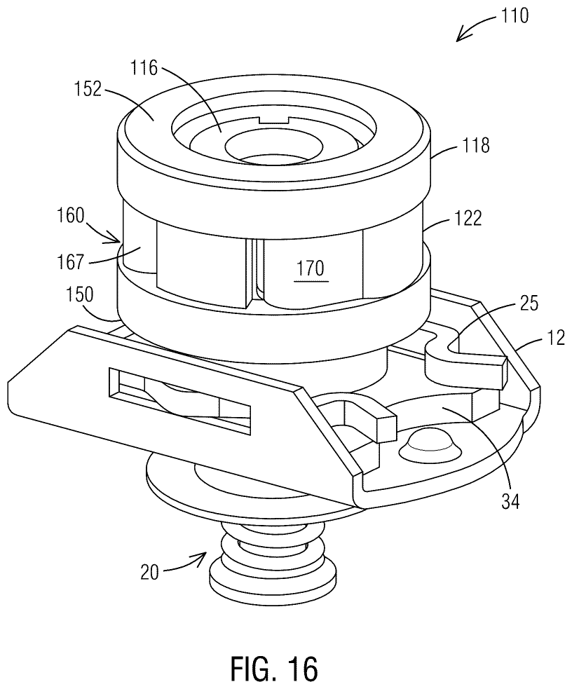

A second embodiment is shown in an exploded view in FIG. 15, and in assembled form in FIG. 16. The components including insert 16, retainer device 25, nut plate 12 and stud/grommet assembly 20 are the same as those of the first embodiment. Components including the actuator 118, retainer clip 122, and receptacle 114 have different configurations, but the fastener assembly 110 of this embodiment functions in an equivalent manner as that of the first embodiment 10. That is, a planar member or tab 170 is biased in an out of a channel of the insert 116 by operation of an actuator and a spring-loaded clip, so the insert 116 may be moved between locked and unlocked positions for axially positioning of the insert 116 in the receptacle 114.

In reference to FIGS. 16, 17 and 18, the actuator 118 is shown in more detail. As shown, actuator 118 has a generally hollow, cylindrical configuration including an open first end 150 and an open second end 152. The retainer clip 122 is spring loaded and has a band configuration and is seated within circumferentially extending groove 160 between the first end 150 and second end 152 on a body 145 of the actuator 118.

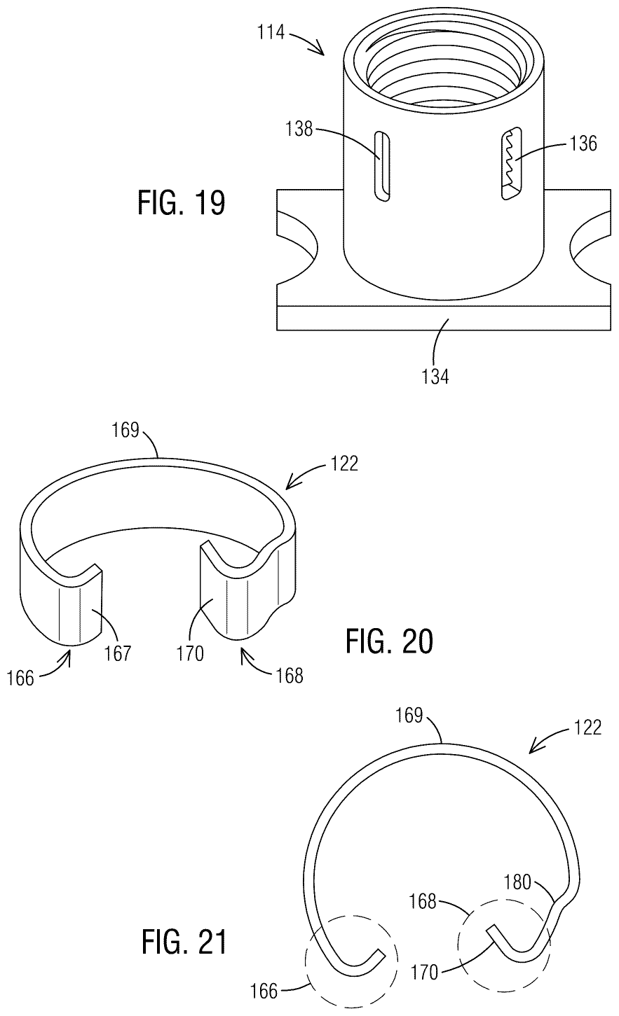

The retainer clip 122 includes a first hooked end 166 with a tang 167 spaced from a second hooked end 168 that includes a radially and inwardly extending planar member or tab 170 spaced from the first end 166. A curvilinear mid-section 169 integrally connects the first end 166 and second end 168. As shown in FIG. 19, the receptacle 114 includes a detent 138 for receiving the tang 167 of the first end 166 to anchor the clip 122 on the receptacle 114. In addition, tab 170 is disposed in or through slot 136 of the receptacle 114 when the fastener assembly 110 or insert 116 is in a locked position.

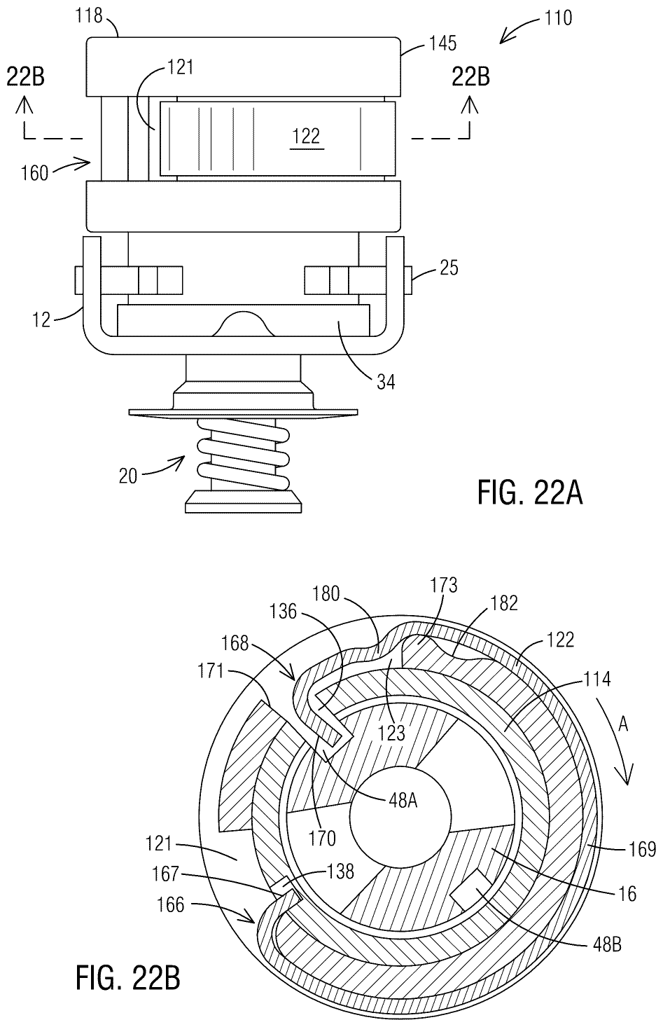

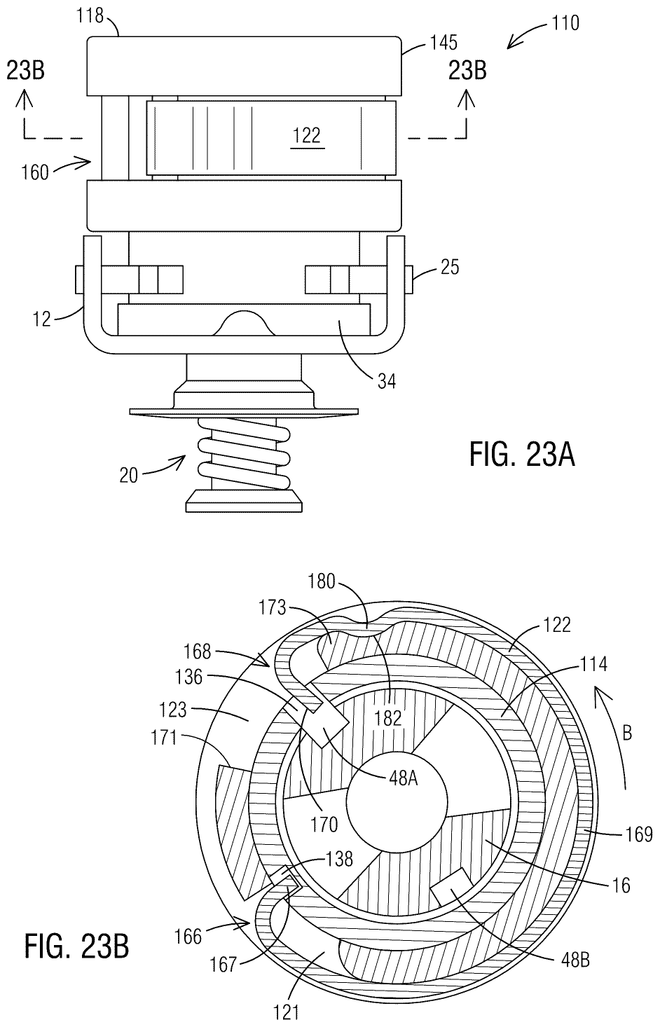

In a locked position (FIGS. 22A, 22B), in which channel 48A or 48B is aligned with the tab 170, the tab 170 extends through slot 136 and into channel 48A, 48B inhibiting rotation and axial movement of the insert 16 in the receptacle 114. In an unlocked position (FIGS. 23A, 23B), the actuator 118 is rotated biasing the tab 170 radially outward relative to the insert 16 removing the tab 170 from the channel 48A, 48B and allowing rotation of the insert 16 for axial movement thereof in the receptacle.

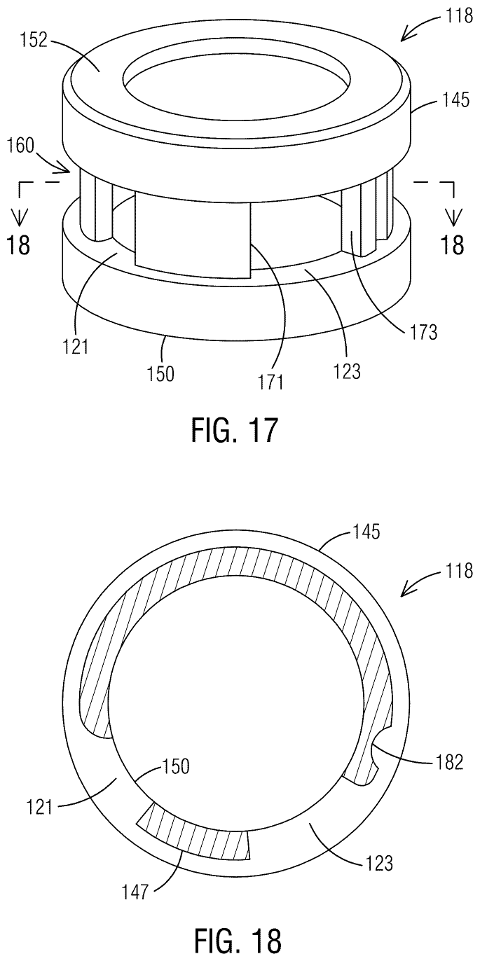

In reference FIGS. 17 and 18, the actuator 118 includes a first side opening 121 and a second side opening 123 spaced from the first side opening 121 along the body 145 of the actuator 118. Openings 121, 123 may also be referred to as windows, slots, recesses etc. As shown, a divider 147 is disposed between the openings 121, 123. With respect to FIGS. 16, 22B, and 23B, the tang 167 of the second end 168 of the clip 122 extends through the first opening 121 and into the detent 138 of the receptacle 114 and with the compressive force of the clip 122 seats and anchors the retainer clip 122 in circumferential groove 160 on the body 145 of the actuator 118.

In reference to FIGS. 22A and 22B, the tab 170 on the second end 168 of the clip 122 extends radially inward through the second opening 123, the slot or detent 138 of the receptacle 114 and into channel 48A, 48B of the insert 16. The fastener assembly 110 is shown in a locked position, or an insert locked position. As shown, and explained above, the spring-loaded nature of clip 122 biases the tab 170 radially inward into channel 48A, 48B. To that end, positioning of the tab 170 in channel 48A, 48B inhibits or prevents axial movement or rotation of the insert 16 in the receptacle 114 for purposes of securing two panels together.

With respect to FIGS. 23A and 23B, the fastener assembly 110 is shown in an unlocked or insert unlocked position. With respect to FIG. 23B, the actuator 118 has been rotated in direction of arrow B. Note, FIG. 23B is a sectional view taken along line 23B-23B showing a bottom sectional view. Accordingly, arrow B shows rotation in a counterclockwise direction; however, when viewing the insert from above, the direction of rotation is in a clockwise direction to an unlocked position.

As shown FIG. 23B, the clip 122, or second end 168 of clip 122 has been biased radially outward relative to the insert 16 so the tab 170 is no longer disposed within channel 48A, 48B. FIG. 22B shows the fastener 110 in a locked position, and in order to place the fastener assembly in an unlocked position the actuator 118 is moved in the direction of arrow B (FIG. 23B). The second end 168, or mid-section 169 toward the second end 168 of the clip 122, may include a projection 180 facing the receptacle 114 and insert 16.

In the locked position the projection 180 is disposed between side edges 171, 173 (173 is also referred to as the tab-end) of opening 123, or between that tab 74 and tab-end 173 of the mid-section 169. Projection 180 of an embodiment may take the form of an undulation or bend in the band clip 122, but may take other forms such as protuberance, bump, dimple on a flat surface of the band clip 122.

As the actuator is rotated in direction of arrow B, from an insert locked position of FIG. 23A, A tab-end 173 of the body 145 at the opening 123 engages the projection 180 forcing, biasing or moving the tab 174 outward relative to channel 48A, 48B to the unlocked position of FIG. 23B. In this manner, the insert 16 may be rotated within receptacle 114 to adjust the axial position of the insert 16 to accommodate, for example, panels that may vary in thickness. Once the axial position of the insert 16 is adjusted to a desired height within the receptacle 114, the actuator 118 may be rotated in direction of arrow A, FIG. 22B, so the projection 180 is at the opening 123, and the spring-loaded nature of the band clip 122 biases the tab 170 into the channel 48A, 48B.

In an embodiment shown in FIGS. 22A and 22B, body 145 of the actuator 118 includes a detent 182 corresponding to the curvature of the protrusion 180, which seats in detent 182. Such a configuration provides a tactile feel or notice of movement of the clip 122 from the locked position to the unlocked position and vice versa.

The invention is not limited to the specific embodiments disclosed herein and covers a fastener assembly in which a radius of the retainer clip and radius of an outer surface of the actuator vary relative to one another such that rotation or movement of the actuator results in biasing the clip outward relative to the insert and receptacle. To that end, aspects of the invention wherein this variation in radii between two components is adjacent to a part (including for key 24, for example) that is biased in an out of a locking interface with the insert 16 of the fastener assembly 10, 110.

In the first embodiment, the radius of an outer surface (cam surfaces 58A, 58B) of the changes (increases or decreases) adjacent the position of the key 24 and planar member 70 of the key 24. As described above, rotation of the actuator results in movement of the key 24 (tab 70) in and out of a channel 48A, 48B or locking interface with the insert 16. With respect to the second embodiment, the radius of the band clip 122 changes adjacent the tab 170 at the second end 168 of the band clip 122. As described above, the movement of the actuator 118 or engagement or disengagement of the outer surface of the projection 180 biases or urges the tab 170 in and out of locking interface of the insert 16 at channels 48A, 48B.

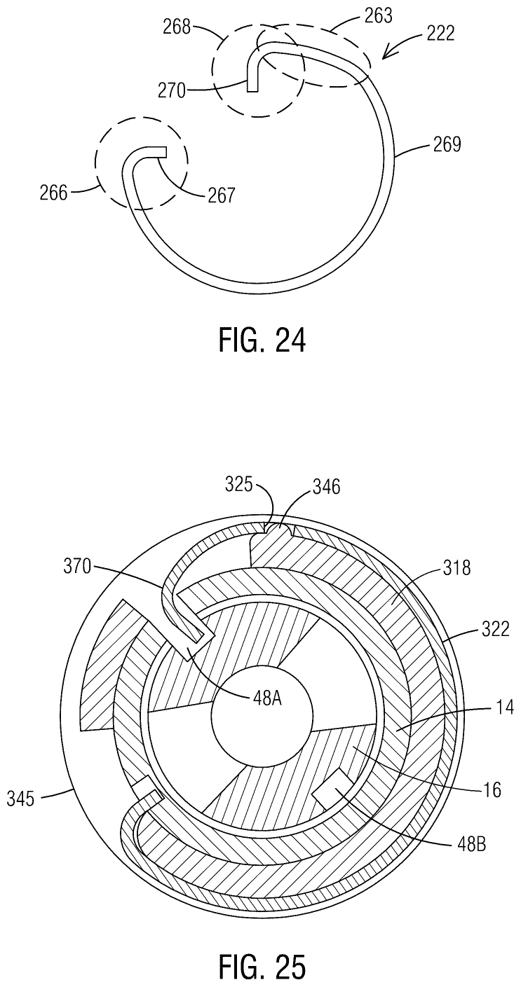

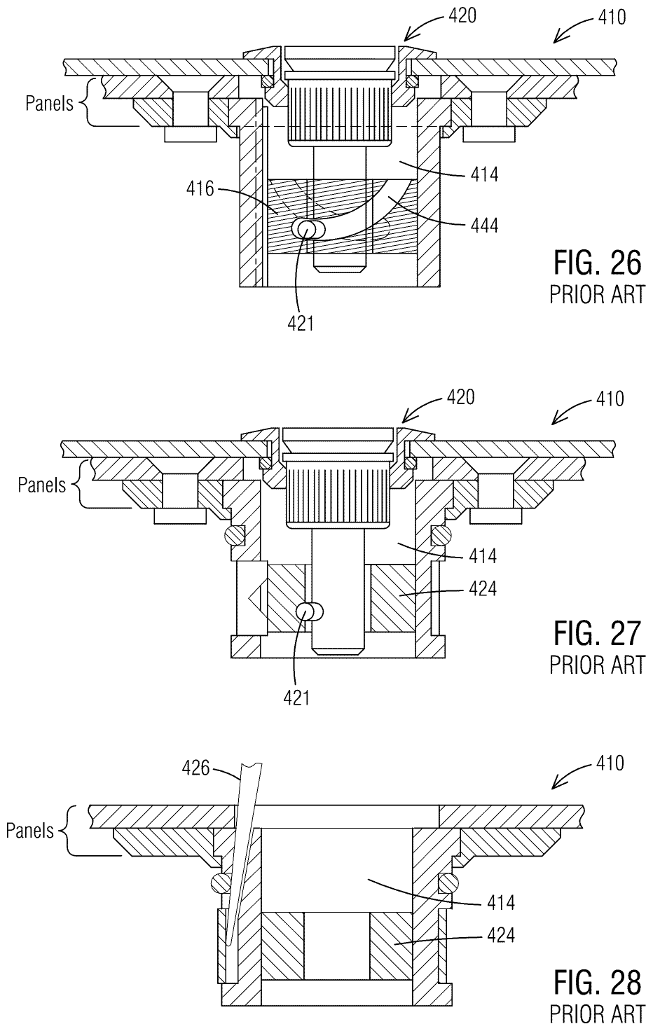

Other embodiments may include, for example, a clip 222 as shown in FIG. 24, which includes a reduction of the radius of clip 222 at portion 263 of the midsection 269 adjacent tab 270 or at toward the second end 268 opposite the first end 266 and tang 267. In another embodiment, the outer surface of the body 345 of the actuator 318 may include a protuberance, projection, bearing (ball bearing) raised portion 346 that interfaces with the band clip 322 at an adjacent a detent, dimple or the like, for example including a hole 325. In the position shown in FIG. 25, the raised portion 346 is seated in hole 325, and the clip 322 urges the tab 370 into the locking interface with the insert 16 or the insert locked position. Rotating actuator 118 in either direction, the raised portion 346 engages the band clip 122 adjacent the hole 325 urging tab 170 out of the channel 48A, 48B to an insert unlocked position.

The components of the fastener assembly 10, 110, except for possibly the actuator 18, 118 are preferably composed of a metallic, or metallic composite, material such as stainless steel and/or an aluminum alloy using known machining techniques and processes. The actuator 18, 118 may be composed of a thermoplastic material such as a glass fiber filled NORYL® thermoplastic.

As has been disclosed above, the present inventor has devised an apparatus with features that are improvements in the art. All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

1. A fastener assembly, comprising:
a nut plate;
an internally threaded cylindrical receptacle supported on the nut plate, wherein the receptacle includes a first end facing a surface of the nut plate and a second end opposite the first end, and a slot through the receptacle between the first end and the second end;
an externally threaded insert disposed within the receptacle and axially adjustable therein, wherein the insert, comprises,
a first end facing the nut plate and a second end opposite the first end;
a boring through the insert including through the first end and second end of the insert;
a pair of diametrically opposed cam and locking surfaces from the second end terminating toward the first end and spaced from the first end, for receiving and engaging a cross pin of a stud;
at least one channel extending from the first end to the second of the insert and through the external threading on the insert, and parallel to a longitudinal axis of the insert; and,
an actuator disposed adjacent to an external surface of the receptable and rotatable thereon, and the actuator comprises;
a cylindrical body disposed over the receptacle having a first end facing the nut plate and a second end opposite the first end; and
an opening through a side of the actuator body between the first end and the second end of the actuator, and the opening includes a first edge and second opposite edge;
a retainer clip having a curved section extending at least partially circumferentially about an external surface of the actuator body and an end extending radially inward relative to the actuator through the opening of the actuator, the slot of the receptacle and into the channel of the insert for an insert locked position, wherein the retainer clip applies a spring-loaded compressive force against the body of the actuator; and,
wherein the actuator is rotatable about the receptacle in a first direction to move the first end of the retainer clip out of the channel of the insert to an unlocked position.

2. The fastener assembly of claim 1 wherein the actuator is rotatable in a second direction to move the first end of the clip into the channel of the insert from the insert unlocked position to the insert locked position.

3. The fastener of assembly of claim 2 wherein the opening of the actuator body is a first opening, and the body of the actuator has a second opening spaced from the first opening.

4. The fastener assembly of claim 3, wherein the end of the retainer clip is a second end and the clip has a first end spaced from the second end, and the receptacle further comprises a detent spaced from the slot and a first end of the retainer clip is seated in the detent of the receptacle through the first opening and the second end of the retainer clip is disposed through the second opening, through the slot of the receptacle an in the channel of the insert in an insert locked position.

5. The fastener assembly of claim 4, wherein the retainer clip has a band configuration from the first end to the second end.

6. The fastener assembly of claim 5, wherein the retainer clip has an inwardly disposed projection within the second opening when the insert is in the locked position and when the actuator is moved to the insert unlocked position the projection is not within the first opening and against the external surface of the actuator.

7. The fastener assembly of claim 6, wherein the actuator has a recess configured to receive the projection of the retainer clip when the actuator is moved to an insert unlocked position.

8. The fastener assembly of claim 1, wherein the actuator further comprises a groove in an outer surface of the actuator that least partially, circumferentially extends on the actuator body and between the first end and second end of the actuator and at least a portion of the retainer clip is disposed within the groove.

9. The fastener assembly of claim 1, wherein in the channel of the insert is a first channel and the insert has a second channel diametrically opposed to the first channel.

10. The fastener assembly of claim 8, wherein the retainer clip has a wire configuration, and the fastener assembly further comprising:
a key including a planar member disposed through the opening of the actuator, through the slot of the receptacle and into the channel of the insert; and,
wherein the key is between the retainer clip and the insert so the retainer clip biases the key toward the insert and into the channel of the insert when in insert is in the locked position.

11. The fastener assembly of claim 10 wherein the opening includes a first edge and second opposite edge and the retainer clip extends across the opening from the first edge past the second edge and the actuator further comprises:
at least one cam surface on the actuator defining an outside surface of the actuator between the first edge and second edge of the opening, and the cam surface ramping radially outward from the first edge to the second edge of the opening; and,
the key has at least one catch connected to the planar member that engages the at least one cam surface; and,
wherein when the actuator is rotated on the receptacle in a first direction the at least one cam surface engages the tab and urges the key radially outward from the channel of the insert to an unlocked position.

12. The fastener assembly of claim 10, wherein when the actuator is rotated in a second direction opposite the first direction the retainer clip urges the key radially inward through the slot of the receptacle and into the channel of the insert.

13. A fastener assembly, comprising:
a nut plate;
an internally threaded cylindrical receptacle supported on the nut plate, wherein the receptacle includes a first end facing a surface of the nut plate and a second end opposite the first end, and a slot through the receptacle between the first end and the second end;
an externally threaded insert disposed within the receptacle and axially adjustable therein, wherein the insert, comprises,
a first end facing the nut plate and a second end opposite the first end;
a boring through the insert including through the first end and second end of the insert;
a pair of diametrically opposed cam and locking surfaces from the end terminating toward the first end and spaced from the first end, for receiving and engaging a cross pin of a stud;
at least one channel extending from the first end to the second of the insert and through the external threading on the insert, and parallel to a longitudinal axis of the insert; and,
an actuator disposed around an external surface of the receptable and rotatable thereon, and the actuator comprises;
a cylindrical body disposed over the receptacle having a first end facing the nut plate and a second end opposite the first end; and
an opening through a side of the actuator body between the first end and the second end of the actuator, and the opening includes a first edge and second opposite edge;
a retainer clip having a curved section extending at least partially circumferentially about an outside surface of the actuator body and an end extending radially inward relative to the actuator through the opening of the actuator, the slot of the receptacle and into the channel of the insert for an insert locked position, wherein the retainer clip applies a spring-loaded compressive force against the body of the actuator; and,
wherein a radius of the retainer clip and a radius of the actuator vary relative to on another along corresponding sections adjacent the opening of the actuator and upon rotation of the actuator on the receptacle in a first direction to move the end of the retainer clip out of the channel of the insert to an unlocked position.

14. The fastener assembly of claim 13 wherein the actuator is rotatable in a second direction to move the first end of the clip into the channel of the insert from the insert unlocked position to the insert locked position.

15. The fastener of assembly of claim 14 wherein the opening of the actuator body is a first opening, and the body of the actuator has a second opening spaced from the first opening and the second opening.

16. The fastener assembly of claim 15, wherein the end of the retainer clip is a second end and the clip has a first end spaced from the second end, and the receptacle further comprises a detent spaced from the slot and the first end of the retainer clip is seated in the detent of the receptacle through the first opening and the second end of the retainer clip is disposed through the second opening, through the slot of the receptacle an in the channel of the insert.

17. The fastener assembly of claim 16, wherein the retainer clip has a band configuration from the first end to the second end.

18. The fastener assembly of claim 17, wherein the retainer clip has an inwardly disposed projection within the second opening when the insert is in the locked position and when the actuator is moved to the insert unlocked position the projection is not within the first opening and against an outside surface of the actuator.

19. The fastener assembly of claim 18, wherein the actuator has a recess configured to receive the undulation of the retainer clip when the actuator is moved to an insert unlocked position.

20. The fastener assembly of claim 13, wherein the actuator further comprises a groove in an outer surface of the actuator that least partially, circumferentially extends on the actuator body and between the first end and second end of the actuator and at least a portion of the retainer clip is disposed within the groove.

21. The fastener assembly of claim 13, wherein in the channel of the insert is a first channel and the insert has a second channel diametrically opposed to the first channel.

22. The fastener assembly of claim 20, wherein the retainer clip has a wire configuration, and the fastener assembly further comprising:
a key including a planar member disposed through the opening of the actuator, through the slot of the receptacle and into the channel of the insert; and,
wherein the key is between the retainer clip and the insert so the retainer clip biases the key toward the insert and into the channel of the insert when in insert is in the locked position.

23. The fastener assembly of claim 22 wherein the opening includes a first edge and second opposite edge and the retainer clip extends across the opening from the first edge past the second edge and the actuator further comprises:
at least one cam surface on the actuator defining an outside surface of the actuator between the first edge and second edge of the opening, and the cam surface ramping radially outward from the first edge to the second edge of the opening; and,
the key has at least one catch connected to the planar member that engages the at least one cam surface; and,
wherein when the actuator is rotated on the receptacle in a first direction the at least one cam surface engages the tab and urges the key radially outward from the channel of the insert to an unlocked position.

24. The fastener assembly of claim 22, wherein when the actuator is rotated in a second direction opposite the first direction the retainer clip urges the key radially inward through the slot of the receptacle and into the channel of the insert.
